(19) United States
(12) Patent Application Publication
(10) Pub. No.: US 2019/0278310 A1
(43) Pub. Date: Sep. 12, 2019

(54) DEVICE, SYSTEM AND METHOD FOR ASSESSING AND IMPROVING COMFORT, HEALTH AND PRODUCTIVITY

(71) Applicant: UNIVERSITE DE FRIBOURG, Fribourg (CH)

(72) Inventors: Denis Lalanne, La Tour-de-Peilz (CH); Hamed Seiied Alavi, Lausanne (CH)

(21) Appl. No.: 16/348,939

(22) PCT Filed: Nov. 10, 2017
(86) PCT No.: PCT/EP2017/078946

§ 371 Date: May 10, 2019

(30) Foreign Application Priority Data
Nov. 10, 2016 (EP) 16198282.2

(51) Int. Cl. G05D 23/19; G05B 15/02

(52) U.S. Cl. CPC G05D 23/1917; G05B 15/02

(57) ABSTRACT

The present invention concerns a novel personal approach for measuring, predicting and improving objective and subjective comforts in buildings, preferably office buildings. The system uses a set of interactive connected devices. These devices capture environmental comfort using environmental sensors and perceived comfort through a human-machine dialog, to personalize its messages. The realization of this approach, called “comfort box” is unprecedented and novel both at the conceptual and the interaction design levels.

### TECHNICAL FIELD

The present invention relates to a device, system and method for determining, managing and/or improving comfort of an individual in space, accommodation, habitats, vehicles and/or buildings. The invention also relates to a system, device and method for improving and/or maintaining productivity and/or health.

### BACKGROUND ART AND PROBLEMS SOLVED BY THE INVENTION

In architecture and performance of buildings repertoire, comfort has been a central element of research and development. It is typically measured objectively using simulation and/or environmental sensing systems, in four dimensions: thermal, visual, acoustic, and respiratory.

Nevertheless, recent studies have shown that comfort, as perceived by the users, is a quality that vary significantly depending on gender, physiological state, psychological preferences, cultural background, and even social dynamics.

Gaining insight into perceived, experienced, physiological and/or subjective comfort is still an open problem. This problem is pronounced considering the facts that comfort is a highly temporal variable (i.e. level of comfort or discomfort may change rapidly), and there is a time lag between when we are out of comfort and when we realise it and take an action.

The two common approaches to collect perceived comfort data have major deficiencies. (1) Collecting questionnaires cannot address the temporal property of comfort, and if too frequent, could become distracting, interrupting and/or bothersome. (2) The existing wearable devices are typically too intrusive, creating often discomfort themselves.

With the increase in the time people spend indoor, current value being 90%, comfortable indoor condition plays a significant role in our health, well-being, and performance. On the other hand, providing indoor comfort entails considerable energy consumption. In Switzerland, for example, approximately 50% of the primary energy consumption is attributed to buildings. To strike an optimal balance between comfort and energy use today's constructions increasingly rely on building automation systems (BAS). These systems use optimised schemes for ventilation, heating, lighting and air-conditioning. The used schemes are grounded in statistics and standard values like the size of the room or its ambient temperature. All these systems regulate the building based on average values that are not user-centred parameters.

In addition, a large body of research is currently being carried out on the new ways of living and energy use. Most of these studies need to construct ground truth as what is a desirable, comfortable situation.

An objective of the present invention is to assess the comfort of an individual in an accommodation, in a building and/or in space in general. It is also an objective to assess comfort in an individualized manner, with respect to a particular user and/or inhabitant, in particular with respect to individual preferences.

It is an objective of the present invention to assess and determine environmental parameters that are relevant to the comfort of an individual, and to determine the relevance of environmental parameters for a particular individual.

It is also an objective of the invention to improve the comfort of an individual, for example by assessing environmental parameters that may be relevant for comfort, and/or by collecting data or information from an individual for assessing the comfort of the individual. It is also an objective of the invention to inform an individual of situations and/or environmental circumstances which may hamper the comfort of an individual.

It is an objective of the invention to determine and/or improve environmental comfort, physiological comfort and/or perceived comfort of an individual.

It is an objective of the invention to determine and/or improve thermal, acoustic, visual comfort and air quality.

Comfort of an individual is related to the individual's health as well as productivity, for example at work. Therefore, the present invention seeks to improve comfort and/or to assess comfort with the goal of improving health and/or productivity.

US2016/0195856 discloses a stationary room robot located on the ceiling that can have various sensors, actuators and electronics. It comprises an embedded controller. The device combines light producing elements, fragrance generators, odor eliminators, air cleaners, an ion generator, a fan, and a speaker system so as to modify the atmosphere and to provide physical as well as mental well-being or mood to an occupant. This system is configured to directly modify the environment. It lacks a function of detecting and communicating the imminence of an uncomfortable situation. Furthermore, while this system can receive orders from an occupant, it is not configured to invite an occupant to provide feedback with respect to the comfort situation as determined by the system. There is no learning with respect to the assessment of a comfort level.

US2016/0252267 is concerned with the management of the temperature in a building. Instead of providing temperature at the various parts of the building, temperature is assessed by way of sensors carried by individuals that are present in the building. The information can also be used to determine the spaces within the building are used and at what time by the individuals. While the system allows individuals to communicate whether they wish a space to be warmer or cooler, the device does not anticipate nor communicate any uncomfortable communication. This system has the same drawbacks as discussed above for US2016/0195856. Finally, amongst the environmental parameters, this reference only teaches the use of air temperature for assessing thermal comfort and only assesses thermal comfort based on temperature. This reference is entirely silent about other types of comfort, such as air quality, visual or auditive comfort, for example.

US2016/0223215 also focuses on thermal comfort of an occupant. An occupant may provide information via a smartphone, a web-based platform or a thermostat interface about the perceived thermal comfort (“too cool”, “too warm”). The system uses this information to provide a thermal comfort map that is used to control the temperature in a conditioned space. This reference is silent with respect to comfort types other than thermal comfort. While the system disclosed takes user feedback into account, it is not proactive in that it is not configured to incite an occupant to provide input and/or to confirm comfort status in order to improve comfort assessment.

In addition to the above deficiencies in the state of the art, there seems to be a lack of a system that is concerned with the three comfort levels that are the environmental comfort, the physiological comfort and the perceived comfort. Furthermore, the prior art focuses on thermal comfort and generally neglects other comfort types, such as visual, acoustic and respiratory comfort.

The present invention addresses the problems depicted above.

### SUMMARY OF THE INVENTION

In an aspect, the present invention provides a method, system and/or device for sensing, measuring predicting and/or improving comfort of individuals in buildings, space, vehicles, habitats and/or accommodation.

In an aspect, the present invention provides a system, device and a method for determining, managing and/or improving comfort of an individual in space, accommodation, a vehicle, a habitat and/or a building.

In an aspect, the present invention provides a method, system and/or device for predicting and/or improving comfort and/or producing a warning if an uncomfortable situation (discomfort pattern) occurs or is imminent to occur.

In an aspect, the present invention provides a device comprising: a plurality of sensors for measuring environmental parameters in said space, habitat, accommodation, vehicle and/or building; an output unit configured to output signals and/or information related to said environmental parameters and/or to a comfort level and/or status determined at least partially from measured environmental parameters; one or more input units configured to be used by said individual to provide input with respect to a comfort as perceived by said individual.

In an aspect, the present invention provides a system comprising: a device comprising one or more sensors for measuring environmental parameters in said space, habitat, accommodation, vehicle and/or buildings; an output unit configured to output signals and/or information related to said environmental parameters and/or to a comfort level and/or status determined at least partially from measured environmental parameters; one or more input units configured to be used by said individual to provide input with respect to a comfort perceived by said individual.

In an aspect, the present invention provides a system for determining, managing and/or improving comfort of an individual in a building, space, an accommodation, a habitat, and/or a vehicle, the system comprising: a device comprising a plurality of sensors for measuring environmental parameters in said building, space, accommodation, habitat, and/or vehicle; wherein said system is configured to determine a comfort level and/or status based on said measured environmental parameters, wherein said comfort level is established for one or for several comfort types combined or separately; wherein said system is further configured to determine one or more discomfort patterns with respect to said comfort levels or status, said discomfort patterns indicating the occurrence of an uncomfortable comfort level and/or status; wherein the device further comprises: an output unit, wherein said system is configured to output signals and/or information related to said comfort level on said output unit; one or more input units configured to be used by said individual to provide input with respect to perceived comfort, said perceived comfort level being related to a comfort level as perceived by said individual, wherein said system is configured to output on said output unit information or warning in the event that a discomfort pattern occurs or is predicted to occur.

In an aspect, the present invention provides a method for sensing, managing and/or improving comfort of an individual in space, a habitat, an accommodation, a vehicle and/or a building where the individual sojourns.

In an aspect, the present invention provides a method comprising: measuring environmental parameters in said space, habitat, vehicle, accommodation and/or building; outputting signals and/or information related to said environmental parameters and/or to a comfort level and/or status determined at least partially from measured environmental parameters; and, requesting input from said individual with respect to a comfort as perceived by said individual.

In an aspect, the present invention provides a method for improving productivity and/or maintaining health, the method comprising predicting uncomfortable situations and/or producing a warning if an uncomfortable situation is predicted and/or is determined to occur.

In an aspect, the present invention provides a method for improving productivity and/or improving health of an individual in a building, the method comprising: measuring environmental parameters in said space, accommodation and/or building; determining a comfort level and/or status based on said measured environmental parameters, wherein said comfort level is established for one or for several comfort types combined or separately, determining or using one or more discomfort patterns with respect to said comfort levels, said discomfort patterns indicating the occurrence of an uncomfortable comfort level, and, generating an information and/or warning in the event that a discomfort pattern determined to occur or is predicted to occur.

In an aspect, the invention provides a device configured to conduct the method of the invention.

Further aspects and preferred embodiments of the invention are defined herein below and in the appended claims. Further features and advantages of the invention will become apparent to the skilled person from the description of the preferred embodiments given below.

### BRIEF DESCRIPTION OF THE DRAWINGS

FIG. 1 schematically shows the system of the invention and its architecture according to an embodiment.

FIG. 2 schematically shows the system of the invention and its architecture according to another embodiment.

FIG. 3 a schematic representation for illustrating the system of an embodiment of the invention and the operation thereof.

FIG. 4 is an image illustrating a design solution of an interactive device according to an embodiment of the system of the invention.

FIG. 5 is a photograph of a device realised on the basis of the concept illustrated in FIG. 4.

Hereinafter, certain preferred embodiments of the device of the invention are described, in order to illustrate the invention, without any intention to limit the scope of the present invention.

### DETAILED DESCRIPTION OF THE PREFERRED EMBODIMENTS

The present invention provides a system, device and method concerned with comfort of subjects in space, preferably in accommodation and/or buildings. The term “comfort” preferably encompasses an aspect “well-being” of comfort, in as far as well-being and comfort are determined or influenced by external, for example environmental factors.

The present invention preferably provides a system, a device and methods for sensing, measuring, determining, managing, predicting and/or improving comfort of subjects in space, in particular in confined space, for example buildings. The system and/or device of the invention are preferably configured to conduct the methods of the present invention.

The system of the present invention is particularly conceived for office buildings, in particular for operation in working space such as offices. The invention is, however, not limited to use in such an environment and may be used in any building, accommodation, habitat and/or space, in particular in which one or more individuals sojourn, for example in space where individuals stay for the purpose of working. The present invention may also be used for home space, for example housing, apartments, and so forth.

In an embodiment, the building is a building accessible to the public or to part of the public, such as a university, school, library, station, airport, hospital, museum, gallery, and the like.

In an embodiment, the habitat, building, accommodation and/or space is non-moving and/or permanent.

The accommodation or space may also be space in a train, airplane, space-craft, space-station, or any other type of vehicle, transporting entity and/or habitat, be it public, private, governmental, extra-terrestrial and/or otherwise, including closed habitats. In some embodiments, the present invention applies to comfort in moving accommodation, such as vehicles.

The individual is preferably a human individual. Preferably, said building, space, accommodation, habitat, and/or vehicle comprises space in which the individual sojourns for at least some time, preferably regularly, constantly, intermittently, repeatedly, temporarily, and/or occasionally.

In a preferred embodiment, the present invention preferably addresses different types and/or dimensions of comfort, including one or more selected from the group consisting of: thermal comfort, visual comfort, acoustic comfort, and/or respiratory comfort.

The device, system and/or method of the invention preferably comprise and/or are configured to determining a comfort level and/or status for each of two or more different comfort types selected from the group consisting of: thermal comfort, visual comfort, acoustic comfort, and/or respiratory comfort.

The expression “comfort level and/or status” expresses that comfort may be assessed in a gradual, discrete or continuous manner as well as in an absolute manner. For example, the expression “I am comfortable” relates to an absolute manner of assessing comfort, whereas “I am almost comfortable” would indicate comfort in a gradual manner. In the present specification, the expression “comfort level” is used for both possibilities, including s comfort status.

The present invention is preferably concerned with one or more selected from the group of: environmental comfort, physiological comfort, and/or perceived comfort.

For the purpose of the present specification, “environmental comfort” is based on environmental parameters measured in the space around the occupant, e.g. the CO₂ level, the temperature, the luminescence, for example. The environmental comfort does preferably not take into account individual preferences. Generally, environmental comfort is preferably determined on the basis of preexisting norms, heuristics and/or information applicable to the average population concerned, or a population group concerned. The aforementioned norms may be norms destined to or used by the constructors or conceivers of buildings, for example. For example, in accordance with the “environmental comfort”, the system of the invention may determine the presence of an uncomfortable situation (discomfort pattern, see below) if the temperature is higher or lower than the temperature that an average person would consider as comfortable. Accordingly, discomfort patterns may be predefined based on previously collected or available information, in the absence of an individual's personal preferences or feedback. Of course, when assessing “environmental comfort”, the system may take into account biometric or general information with respect to an individual, if such information is available to the system (gender, age, weight, etc). “Environmental comfort” may sometimes also be referred to as “objective comfort”.

For the purpose of the present specification, “physiological comfort” concerns the subject, i.e. the occupant himself, and is directly derived from physiological measures such as eye blinking, skin conductance, skin temperature, conducted on the individual. For example, the system of the invention may determine the presence of a discomfort pattern if the skin conductance indicates that the person on which the measurement is taken is sweating, if the skin temperature is elevated, or if a heart rate is above average.

For the purpose of the present specification, “perceived comfort” and “comfort as actually perceived” is the comfort as expressed by the individual, his or her perception of the comfort quality, e.g. “I am too hot”, “It is noisy” at a particular moment of interaction of the individual with the system and/or device of the invention.

The perceived comfort is thus generally based on feedback provided by an individual.

“Perceived comfort” and “physiological comfort” may also be considered as “subjective comfort” or “personal comfort”. The “personal comfort” takes thus preferably the feedback of an individual into account, as well as physiological information.

The present invention preferably assesses at least environmental comfort, preferably also perceived comfort. In an embodiment, the present invention is concerned with all three aspects of comfort: environmental, physiological and perceived comfort. The invention is thus preferably also concerned with and may take into account the personal comfort.

The system of the invention may determine the presence of an uncomfortable situation or may predict the uncomfortable situation based on a “discomfort pattern”. In an embodiment, a discomfort pattern may be defined as a threshold, reference or comparison value, such that an uncomfortable situation occurs if any measured parameter or comfort level is at, below or above the corresponding threshold, reference or comparison value. In a preferred embodiment, a “discomfort pattern” takes several parameters into account and goes thus beyond a simple threshold value.

For example, a “discomfort pattern” may be established on the basis of several environmental factors and/or on the basis of a comfort level. For example, an uncomfortable thermal comfort situation (thermal discomfort pattern) may be obtained if temperature is high and humidity low, but also if temperature is less high but humidity is high.

Furthermore, a “discomfort pattern” may take past events into account, including parameters determined in the time preceding an actual moment of assessment. To make an example, a “discomfort pattern” with respect to thermal comfort may be determined if the environmental temperature or thermal comfort level is slightly below a reference temperature or thermal comfort level for a particular amount of time. If the gap between the reference temperature and the environmental temperature is larger, the time needed for a discomfort pattern to occur is expected to be shorter. Furthermore, the season or outside temperature may be taken into account.

To make yet another example, this time related to acoustic comfort: a particular noise level may not be considered uncomfortable if it remains below a particular value, but may trigger a discomfort pattern of an individual if it lasts more than a particular amount of time. Also rapid changes of environmental parameters may define discomfort patterns. In short, discomfort patterns refer to situations generally defined by several parameters, factors and including time and dynamics that indicate the presence of a situation that is uncomfortable to an individual.

As mentioned elsewhere, perceived comfort and/or physiologic data may also be and preferably are indeed considered in the determination of a comfort level and/or discomfort pattern in as far as such data is available. In this regard, the comfort level and/or discomfort pattern as determined by the system and/or displayed on the output unit may also be considered as an overall comfort.

Since the comfort pattern may take past events and (environmental and other) data into account, the system of the invention may predict the occurrence of discomfort patterns in the future. For example, the system is preferably configured to extrapolate a particular environmental parameter and/or comfort level based an evolution of said environmental parameter and/or comfort level in the past up to the present. For example, the system may understand that temperature is linearly increasing with time and that, therefore, a discomfort pattern is expected to be reached within a given time by extrapolation, for example.

In an embodiment, the system of the present invention is configured to determine a comfort level based on said measured environmental parameters, wherein said comfort level is preferably related to one or several comfort types. Said comfort level may also be considered to be a predicted or determined comfort level, as it is the comfort level as determined by the system. In some embodiments and situations, said comfort level is an “environmental comfort”, in particular if information with respect to a perceived comfort is not available.

It is noted that a particular comfort level as determined by the system may not in all cases represent the actually perceived comfort level. For this reason, the system is preferably capable to learn from user feedback and/or to determine a discomfort pattern based on environmental parameters and user feedback (perceived comfort). It is noted, however, that the occurrence of a discomfort pattern may indeed represent an uncomfortable comfort level to an individual, but the individual may not yet have become aware of the presence of the uncomfortable situation. It is in particular an objective and advantage of the invention to inform about an uncomfortable situation and/or to predict the imminence of an uncomfortable situation before the individual becomes conscient of it.

Furthermore, the system of the present invention is preferably configured to take into account input provided by one or more users or individuals with respect to a comfort level actually perceived by said individual or individuals (“perceived comfort”). For determining comfort level and for determining a discomfort pattern, the system preferably takes said user input into account if and in as far it is already available. It is expected that the longer the system is used by a particular individual, the more accurate the assessment and prediction of a comfort level and/or a discomfort pattern may become.

Said comfort level may be and encompasses an individual comfort level. The term “individual” is considered to encompass “personal” and expressed that said comfort level or said discomfort pattern as determined by the system may be specific to a particular individual or a group of individuals and thus not necessarily valid for other or all individuals. The present invention is preferably adapted to and/or allows for personalization, in particular by learning on the basis of input received from a user.

Accordingly, the present invention preferably involves machine learning and personalization with respect to assessment or prediction of comfort/discomfort.

In an embodiment, the system of the invention is configured to determine an individual comfort level, and/or an individual discomfort pattern based on said measured environmental parameters 30 and further based on the input received from said individual via said one or more input unit 60. Said comfort status and/or said discomfort pattern may be an individual comfort status and an individual discomfort pattern, respectively.

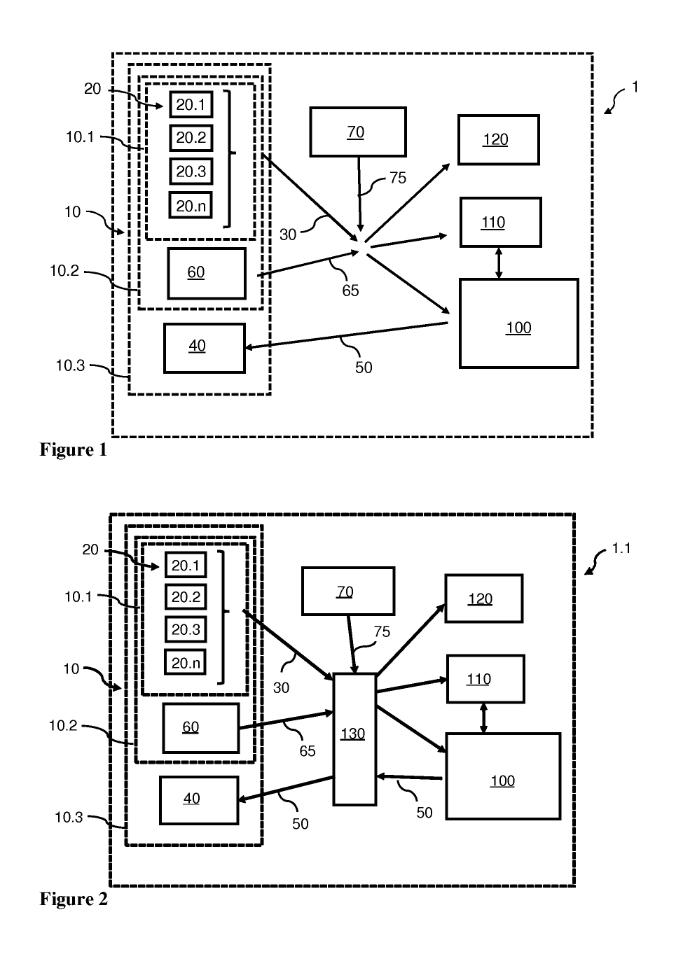

FIG. 1 illustrates an embodiment of the system 1 of the invention. The system preferably comprises one or more sensors 20, preferably a plurality of sensors 20.

For the purpose of the present specification, the term “comprising” and its various grammatical forms is intended to mean “includes, amongst other”. It is not intended to mean “consists only of”.

In FIG. 1, individual sensors are indicated with reference numerals 20.1, 20.2, 20.3, 20.n. The sensors are preferably sensors that are suitable for measuring environmental parameters in said space, accommodation and/or building. The present invention is in principle not restricted to a particular number of sensors. It is noted, that the present invention preferably assesses different types of comfort and thus preferably comprises several, different sensors for assessing different comfort types. For example, for assessing visual comfort, a light sensor is preferably included, and for assessing thermal comfort, a temperature sensor is included. The letter n in 20.n is intended to refer to the total numbers of sensors in a device 10 and/or in the system 1, 1.1. In an embodiment, the system comprises 1-100 sensors, preferably 2-50 sensors, more preferably 3-30 sensors, even more preferably 4-20 sensors, for example 5-15 sensors.

In an embodiment, the method comprises measuring environmental parameters 30 in said space and/or accommodation. To this end, the device 10 of the invention preferably comprises one or more sensors 20, preferably a plurality of sensors 20.

In an embodiment, said one or more sensors 20 comprise one or more sensors selected from the group consisting of: a temperature sensor, a humidity sensor, an air pressure sensor, an air flow sensor, a luminosity sensor, a sound sensor, a CO₂ sensor and an accelerometer.

Preferably, the system of the invention comprises one and for some types of comfort preferably more than one sensors for each type of comfort. For assessing some types of comfort, such as thermal and/or air quality comfort, a combination of two or more sensors may be used.

In an embodiment, the system of the invention comprises one or more sensors selected from the group consisting of: a temperature sensor, a humidity sensor, and an air flow sensor for assessing thermal comfort. Preferably, the system is configured to analyse the output and/or data from one or more of these sensors.

In an embodiment, the system of the invention comprises one or more sensors selected from the group consisting of: a humidity sensor, an air pressure sensor, an air flow sensor, and a CO₂ sensor for assessing air quality, comfort related to air quality. Preferably, the system is configured to analyse the output and/or data from one or more of these sensors.

In an embodiment, the system of the invention comprises one or more luminosity sensors for assessing visual comfort. Preferably, the system is configured to analyse the output and/or data from one or more of these luminosity sensors.

In an embodiment, the system of the invention provides one or more sensors selected from the group consisting of: one or more sound sensors for assessing acoustic comfort. Preferably, the system is configured to analyse the output and/or data from one or more of these sound sensors.

In an embodiment, the device, system and/or method of the invention encompasses the assessment and/or prediction of comfort levels and/or discomfort patterns of two or more of the aforementioned comfort types, preferably three or all four of these comfort types (thermal, air quality, visual and acoustic comfort). For example, if the device, system and/or method of the invention is related to two or three of these comfort types, all combinations are encompassed by the invention.

In the embodiments herein after, the following abbreviations are used: t=thermal comfort, q=air quality comfort, v=visual comfort, a=acoustic comfort. For example, an embodiment with only two comfort types is realized, the embodiment may be realized with respect to one or more selected from: t+q, t+v, t+a, q+v, q+a, and v+a. In an embodiment realized on the basis of three comfort types, the invention may be realized on the basis of the following combinations, for example: t+q+v, t+q+a, t+v+a, q+v+a.

The system, device and method of the invention comprise and/or are configured to output signals and/or information 50 related to said environmental parameters 30, to a comfort level and/or to the occurrence of a discomfort pattern determined at least partially from measured environmental parameters 30.

In a preferred embodiment, the system of the invention comprises one or more output units 40. The output unit is preferably suitable to output signals and/or information 50 related to said environmental parameters and/or to a comfort level determined at least partially from measured environmental parameters 30. The present invention is preferably not limited to the type or number of output units. The purpose of the output unit is to inform an individual or a person in charge, supervisor, officer, manager, caretaker, etc., about comfort, occurrence of discomfort patterns, in particular about environmental, physiological and/or perceived comfort in accordance with the invention. Preferably, the output unit output signals and/or information that is at least partially determined from measured environmental parameters (environmental comfort).

For the purpose of the present invention, expressions like “determined from” and “based on” in larger expressions such as “a comfort level determined from”, for example, are not intended to mean that said parameter or comfort level is determined only from the indicated variables. It is understood that the parameter, comfort level, value, variable or amount or discomfort pattern is preferably determined while possibly taking into other information and data.

For the purpose of the present invention, the term “unit”, for example as used in the expressions “input unit” and “output unit”, and the like, encompasses and/or corresponds to the term “assembly”, since a unit frequently comprises several distinct elements and/or parts so as to be operational and functional. The same applies to the term “entity”, such as said “data processing entity”, which may preferably also be configured as an assembly comprising one or more parts, preferably integrated in the entity.

For example, the output unit 40 may comprise one or more selected from a loudspeaker, a screen, display, a light source, one or more LEDs, and the like. For example, the system may communicate with an individual via the loudspeaker, for example by producing a acoustic message, created, for example, with a voice generator.

In a preferred embodiment, the output unit comprises a screen and/or display. Preferably, the screen and/or display is suitable to indicate text messages. For example, the output unit is a screen or display suitable to display a sentence saying that the CO₂ level is too high, that luminosity is too low, and the like. The screen or display may also invite an individual to provide feedback related to comfort, in particular to one or more of the comfort types specified elsewhere in this specification. For example, asking an individual whether she/he feels hot and/or has the feeling that it is noisy.

In an embodiment, the system comprises an output entity suitable to indicate a scale, gradual and/or continuous information, comfort level, semi-quantitative indication and/or quantitative indication, and/or an indication of duration. For example, the output entity comprises a display or other optical signal suitable to provide a gradual and/or semi-quantitative indication of a comfort status or environmental parameter, and/or of a duration an environmental parameter or comfort type is outside a comfortable situation. For example, the output entity comprises a display or other optical indicator of a noise level, temperature, CO₂ level and the like.

In an embodiment, said output unit 40 is suitable to provide a gradual and/or continuous information related to said comfort level and/or occurrence of a discomfort pattern.

In an embodiment, the output entity comprises one or more LEDs and/or LEDs suitable to display different colors, preferably for providing a quantitative or gradual indication of comfort, of a parameter relevant to comfort and/or of a duration.

In a particular embodiment, the device and/or system comprises a series of juxtaposed LEDs, wherein the number and/or color of lighted LEDs indicates qualitatively (good or bad), gradually, semi-quantitatively and/or quantitatively comfort level and/or an environmental parameter. In an embodiment, the device and/or system comprises a series of juxtaposed LEDs, wherein the number and/or color of lighted LEDs indicates the duration of an uncomfortable comfort level and/or discomfort pattern, that is, a situation for which the system of the invention has determined that the individual is not comfortable. The duration preferably indicates the time that has passed since the moment of occurrence of the discomfort pattern up to the present, and/or up to receipt of input from the individual which may indicate that the determined comfort level does not correspond to perceived comfort level.

For example, a first color, such red light may be used to indicate that comfort is below a particular threshold and/or another light, such as green light, may be used to indicate that environmental parameters and/or comfort levels are within acceptable ranges. For example a third color, such as yellow color, may be used to indicate that determined comfort is close to, for example closely below or around a discomfort pattern, such as close to a threshold value or range. Of course, threshold values and/or acceptable ranges are determined by the data processing entity 100 and may take into account environmental comfort and/or perceived comfort, for example, and even physiological comfort. In the case of perceived comfort, the system uses information entered previously by the individual, that information being integrated in the algorithms run by the data processing entity 100, as set out in more detail elsewhere in this specification.

In an embodiment, the system and/or device 10 comprises said output unit 40 and/or said one or more input units 60. In an embodiment, the system, device and method of the invention comprise and/or are configured to request, induce or invite said individual to provide input via said one or more input unit 60 with respect to a comfort level as determined by the system and output on said output unit 40.

In an embodiment, the system of the invention comprises one or more input units 60. The purpose of the input units is to enable an individual to enter information or input related to comfort, for example a comfort level as perceived by said individual.

In an embodiment, the input unit may comprise a microphone, allowing an individual to enter an acoustic message, for example a sentence such as “it is hot”.

The input unit may be selected, for example, from a microphone, an acoustic sensor, a keyboard, a computer mouse, tactile sensors, tabs, buttons, and the like. In an embodiment, the input and/output units may be combined, for example in the form of a touch screen.

In an embodiment, device and/or system of the invention comprises an accelerometer. The accelerometer preferably allows interaction with the device and is preferably part of the input unit/assembly. The accelerometer may preferably be configured to sense a user's physical interaction with the device.

In a preferred embodiment, the system of the invention comprises one or more buttons for providing input. Preferably, the input unit may comprise one, two or more buttons for providing yes and/or no answers, and or for navigating in a menu.

For example, the system may also be configured to provide gradual and/or (semi-) quantitative answers, for example, “it is slightly cold”, “it is cold”, “it is very cold”, etc. In case of an input unit comprising buttons, such an answer may be provided, for example, by pushing a button an appropriate number of times, for example expressing said gradual and/or (semi-) quantitative answer, or by selecting an appropriate statement and/or indication in a menu displayed on the output unit 40.

Preferably, said one or more input units 60 are configured to be used by said individual to provide input with respect to perceived comfort. Preferably, the system is configured to induce or invite said individual to provide input via said one or more input unit 60 with respect to a comfort level as determined by the system and output on said output unit 40. In an embodiment, the system of the invention is configured to inquire of said individual to provide input via said input units 60 with respect a comfort actually perceived by said individual. For example, via the output unit 40, the system may invite an individual to provide input, via said input units 60, concerning the individuals perceived comfort. In addition, or alternatively, the input unit 60 is configured to receive input on the initiative of the individual. In accordance with an embodiment, the method of the invention comprises requesting and/or asking said individual to provide input concerning the individuals perceived comfort.

The input may be requested and/or entered in the form of a confirmation or denial of a comfort level as indicated by the output unit 40, for example.

In an embodiment, the system 1 of the invention comprises a data processing entity 100. The data processing entity 100 is preferably a computer or server, comprising a Central Processing Unit (CPU), RAM memory, processor, one or more selected from ROM, EPROM, and flash memory. Preferably, said data processing entity comprises an operation system and is configured and/or adapted to run said operation system and, preferably, application software for assisting in and/or conducting the methods of the invention. The data processing entity 100 preferably comprises software and/or algorithms for operating the system of the invention, in particular for conducting the algorithms and/or applying rules necessary for determining comfort.

In an embodiment, the method, system and device of the invention comprise and/or are configured to transfer data related to said parameters and/or input units to said data processing entity 100, and wherein said data processing entity 100 comprises algorithms for determining said comfort level and/or discomfort pattern.

In an embodiment, the method and system of the invention comprises a data processing entity configured to determine said comfort level and/or discomfort pattern at least partially from said measured environmental parameters 30 and optionally from input received from said individual with respect to a perceived comfort. Preferably, the data processing entity 100 is configured to determine at least one or more selected from: (i) environmental parameters based on data produced and/or measured by said sensors, (ii) a level or value associated with an environmental comfort, (iii) a level and/or value associated with a perceived comfort, and (iv) one or more discomfort patterns.

The data processing entity 100 is preferably configured to receive input related to data 30 collected by said sensors 20, in particular environmental data. Furthermore, the data processing entity is configured to send data and/or information 50 to the output unit 40 with respect to information, sentences, messages, data, etc, to be output, for example displayed, by said output unit.

The system of the invention preferably comprises a database 110. The system is preferably configured to store data received from said sensors 20, from said input unit 60, from said wearable device 70 and/or optionally from said data processing entity 100. For example, the system is configured so as to store environmental data and/or user interaction data.

In an embodiment, the method, system and device of the invention comprises and/or is configured to output via said output unit 40 information related to said personal and/or individual comfort level.

In an embodiment, the method, system and device of the invention comprises and/or is configured to enable transfer of data between one or more selected from: said device 10 and said data processing entity 100, said device 10 and a database 110, and said data processing entity 100 and said database 110.

In an embodiment, the system of the invention further comprises one or more sensors and/or cameras 70 for determining and/or measuring physiological, biological and/or biometric parameters of an individual. The sensors and/or cameras 70 preferably have the purpose of providing data related to a physiological comfort of an individual. In an embodiment, the system comprises a camera, suitable to take pictures, which can be analysed by the data processing entity so as to determine physiological and/or biological information related to the individual from which the image was taken. The camera may be a normal camera, an infrared camera, a hyperspectral and/or multispectral camera, for example. By use of image analysis software, the data processing entity 100 is preferably configured to derive physiological and/or biological parameters from images acquired by said camera.

In an embodiment, the system comprises sensors 70 for measuring data related to physiological and/or biological parameters. In an embodiment, said sensors 70 comprise one or more selected from: a sensor measuring skin temperature, a sensor measuring skin conduction, and a sensor for measuring heart rate.

In an embodiment, the sensors and/or camera 70 are configured to be carried by an individual. In an embodiment, the system of the invention further comprises a wearable device to be carried by said individual, said wearable device comprising one or more of said sensors and/or cameras for determining and/or measuring physiological and/or biological parameters.

In a preferred embodiment, said wearable device is a wrist band and/or a device that can be integrated in a wrist band, for example of a watch. For example, the wearable device is wristwatch.

In an embodiment, the system 1 of the invention comprises one or more separate end-user applications 120. The end user applications may be computers, smart phones, tablets, and the like, that can be configured to receive data and information from the sensors 20, from the input unit 60 and/or from the data processing entity 100. The end user applications may be in the form of software applications that can be downloaded to the cited devices (computers, smart-phones, etc). The end user applications may allow a user and/or individual to consult information generated by the sensors, input unit and/or data processing entity 100.

In an embodiment, the end user application 120 allow configuration of the system, for example by inputting information with respect to user (individual) preferences or user data, such as personal and/or biometric data (age, size, gender, etc).

In an embodiment, the system of the invention comprises at least one device 10, which comprises the one or more sensors 20, and which is configured to emit data and/or information 30 related to the signals measured by the sensors. On the other hand, the data processing entity 100 is preferably configured to receive data 30 related to the signals measured by the sensors. The data processing entity is preferably configured to emit data and/or information 50 to be output by the output unit 40.

The invention envisages several embodiments with respect to the device 10.

In an embodiment, the device 10 comprising said sensors 20, output unit 40 and input unit 60 is suitable for being positioned in vicinity of an individual so that said individual can physically interact with said device 1, and wherein said device 1 is in communication with a remote data processing entity 100, which is configured to determine said comfort level and/or discomfort patterns.

Preferably, the device 10 comprises essentially the sensors 20 and hardware and firmware required for emitting the information 30 collected and/or measured by the sensors. Typically, the device comprises a microcontroller and a wireless module, such as Bluetooth, Wi-Fi, or equivalent wireless connections, for emitting the data. The device 10 may also comprise software and/or firmware, for example for pretreating the signals measured by the sensors, or for controlling and configuring data emitted by the wireless module.

In a first embodiment, the device 10 corresponds to device 10.1. In this embodiment, the input unit 60 and the output unit 40 are not integrated in the same device 10.1, but are separate from the device 10.1. For example, the device 10.1 comprising the sensors 20 may be provided in a room, for example on a desk or at a wall, and the input and output unit may be in the form of a tablet provided in the room, or on a smart watch, for example. In accordance with this embodiment, the input and output units 60, 40, may be integrated in the computer and/or laptop of the individual, for example the computer the individual is working with.

Alternatively, in accordance with this embodiment, the output unit 40 may be a display attached to a wall, and the input unit may be provided elsewhere, for example at the entry of the room. The device 10.1 comprising the sensors 20 may be placed at a strategic position, for example on a wall, at the ceiling, or on the desk.

In accordance with the embodiment of device 10.1, the output and input units may or may not be integrated in a single device, separate from device 10.1, or me be provided as physically separate, independently displaceable entities.

In an embodiment of device 10.1, one or both of the input and/or output entities 60, 40, respectively, may be integrated in the wearable device, for example a smartwatch.

In a second embodiment, the device 10 corresponds to device 10.2. In this embodiment, the device 10.2 comprises the same components as device 10.1, but comprises in addition the input unit 60. Accordingly, the individual may interact directly at the device to enter feedback related to the perceived comfort. In accordance with this embodiment, the output unit 40 is separate from the device 10.2, for example the output unit 40 may be a loudspeaker placed independently from the device 10.2, or a display that is displaceable with respect to the device 10.2

In a third and preferred embodiment of the device 10, the device 10.3 comprises the sensors 20, the input unit 60 and the output unit or display 40. In this embodiment, the device 10.3 preferably comprises the sensors 20, the microcontroller, the wireless module, the input unit 60 and the output unit 40.

Preferably, in accordance with the third embodiment of the device 10.3, the output unit comprises at least a display and preferably LEDs or other light indicators suitable to qualitatively (good or bad) gradually and/or semi quantitatively and/or quantitatively indicating environmental parameters and/or comfort levels. In accordance with this preferred embodiment, the input unit may be provided, for example, in the form of buttons, allowing an individual to confirm or deny an assertion made on the display, for example.

In accordance with the third embodiment, the device 10.3 may be provided in the form of a box, for example a quadratic, cubic or rectangular box that may be placed on the desk of an individual.

Preferably, in order to be unobtrusive, the device 10.3 offers minimal interactivity and stays at the background of the user's attention when not interacted with.

The present invention is in principle not limited with respect to the manner the components and parts of the system are connected physically or wirelessly. For example, the data processing entity 100 and/or the database 110 may be integrated in the same device as device 10, for example in any one of devices 10.1-10.3. For example, the system of the invention may comprise the sensors, 20, the output and input units 40, 60, and the data processing entity, integrated in one physical device. Preferably, however, the data processing entity 100 and/or the database 110 is separate from the device 10, and is connected wirelessly with the latter. Preferably, said device 10 and said data processing entity 100 are configured to transfer data via wireless communication. The device and the data processing entity preferably comprise wireless communication modules.

The wearable device 70 is preferably only connected wirelessly to the system of the invention, for example to the data processing entity 100. Preferably, the end user applications 120 are also associated with or part of separate devices, which are integrated into the system 1 by being wirelessly connected to the system and configured to receive an/or emit data that can be received from and/or emitted by the data processing entity, for example.

In all embodiments, 10.1-10.3, it is generally preferred that the sensors and the output and/input units are provided in the same room. They may be independently provided displaceably or in a fixed position in that room. This does not always and/or not necessarily apply in the embodiment where the input and/or the output unit 40, 60 are integrated in a wearable device, carried by the individual, for example a smartwatch.

The device 10.1-10.3 is preferably displaceable in the room and/or office in which it is placed during operation of the system.

In an embodiment, the device, system and/or method of the method of the invention comprises and/or is configured to determine, on the basis of algorithms and/or rules, one or more discomfort patterns with respect to said comfort levels, said discomfort patterns indicating the occurrence of an uncomfortable comfort level and/or an un comfortable or discomfortable situation.

In an embodiment, the device, system and/or method of the method of the invention comprises and/or is configured to determine, on the basis of algorithms and/or rules, one or more selected from (i) a comfort level related to any one or more comfort types specified elsewhere in this specification, (ii) whether a limit or range of an environmental parameter associated with comfort is exceeded, fallen below and/or otherwise trespassed, (iii) whether a limit, range or pattern of a comfort level or type is exceeded, fallen below and/or otherwise trespassed, including whether a discomfort pattern has occurred, (iv) the gradual, qualitative, semi-quantitative and/or quantitative extent by which a limit, range or pattern associated with comfort and/or an environmental parameter is trespassed, (v) the duration in time that the limit, range or pattern has been trespassed.

In an embodiment, the system of the invention is configured to output on said output unit 40 information and/or warning in the event that a that a discomfort pattern occurs or is predicted to occur. For example, such information may be produced on the basis of the events and date in points (ii), (iii), (iv) or (v) above.

On the basis of limit values, ranges, threshold values and/or patterns available to the data processing entity and/or used by the algorithms, the system and/or data processing entity 100 generally determines the occurrence of an “uncomfortable situation” or discomfort pattern. This preferably occurs in real time, and is also preferably communicated via the output unit 40 in real time.

In an embodiment, the system of the invention is configured to determine: a) whether said discomfort pattern is predicted to occur within a predetermined period of time; and/or, b) that a comfort level is in a predetermined vicinity of a discomfort pattern; said system being configured to determine the occurrence of an imminence of a discomfort pattern if the conditions under a) and/or b) are met.

Preferably, said system is further configured to output on said output unit 40 information and/or a warning related to said imminence of discomfort pattern. Said “imminence” may be considered to be a certain likelihood and/or high probability that an uncomfortable situation, comfort status and/or discomfort pattern is to occur within a particular, predetermined time. Preferably, the particular amount of the probability and/or the predetermined time are configurable and adapted to a particular situation. Accordingly, the parameters indicating the “imminence of discomfort pattern” may also be variable and adjustable, be it by the technician or they may be subject to adjustment based on user feedback.

Limit levels, threshold values and ranges may be preset or programmed in the data processing system, for example for noise level in decibel, CO₂ concentration, oxygen concentration, air movement in terms of volume per time entity, speed or air flow, light intensity, temperature in ° C. or ° F., humidity as relative humidity, for example

The algorithms may combine data from several sensors to determine a discomfort pattern and/or limit levels for a particular comfort type, as specified elsewhere in this specification. Alternatively, and/or in addition, limit levels and/or discomfort patterns may be provided for each environmental parameter or for certain key environmental parameters as directly determined by one sensor, such as for example, CO₂ level, temperature, noise level and luminosity.

In an embodiment, the system, device and/or method of the invention comprises or is configured to emit and/or send information 50 to be output on the output entity 40 by the data processing entity 100, and/or outputting information 50, for example by displaying on a display and/or a screen, or by lighting light signals.

In an embodiment, the device and/or or system is configured to output information with respect to a comfort level upon request from an individual. For example, in the event that a screen is relatively small to show information with respect to all comfort types, the user may use a button to switch between comfort types and thereby induce the output of information of predicted comfort of a particular comfort type. The invention also envisaged that the output unit produces a table indicating information (for example, comfort status, discomfort patterns, duration of the latter, etc.) related to one, several or all comfort types.

As becomes apparent, one goal or concept of the present invention is to use environmental parameters and to request input from an individual in order to determine as well as possible the perceived comfort of an individual. The invention encompasses collection physiological parameters (body temperature etc) and taking this information into account when predicting perceived comfort. The invention preferably encompasses predicting the occurrence of an uncomfortable situation. The invention preferably encompasses individualization and/personalization by way of machine learning, using user feedback when predicting comfort. The invention preferably encompasses warning an individual of the presence and/or imminence of an uncomfortable comfort situation. The latter feature is helpful, due to the time lag that the present inventors have observed between the occurrence of an uncomfortable situation and the moment an individual becomes aware that she/he feels uncomfortable.

FIG. 2 shows a system 1.1 according to a preferred embodiment of the invention. FIG. 2 specifies the presence of a broker and/or event bus 130. The broker and/or event bus 130 is configured to received data 30 of the sensors 20 and/or from device 10 and to forward the data to other components of the system 1, such as to the data processing entity 100 and/or to the database 110.

Preferably, the broker 130 provides a messaging system for receiving, transmitting and/or forwarding information and data between the components of the system in accordance with the invention. In an embodiment, the broker 130 comprises a message-oriented middleware system.

The broker 130 is preferably configured for inter-process communication (IPC) or for inter-thread communication within the same process. The broker 130 may also comprise a group communication system (GCS).

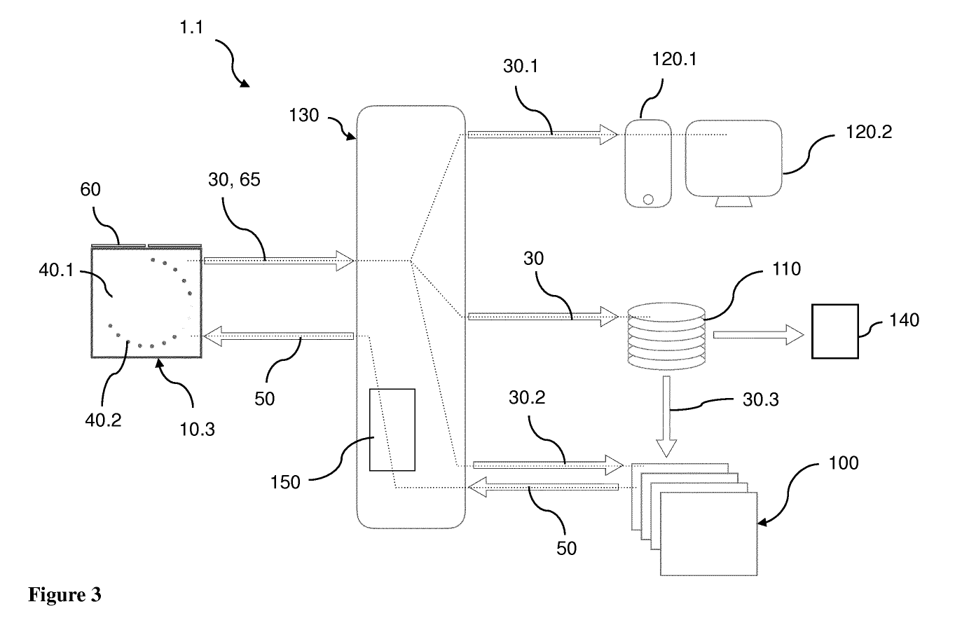

In an embodiment, the broker 130 may run publisher/subscriber models, which may be made available through an API (Application Programming Interface) 150 (FIG. 3).

In an embodiment, the broker 130 may run a message queue and/or mailbox based system for managing the exchange of data and/or information in accordance with the invention.

In an embodiment, the broker 130 may comprise a publish-subscribe messaging system. Preferably, in such a messaging system, the device 10 comprising the sensors and/or the wearable device 70 may act as publisher on the broker, and the data processing entity may act as a subscriber, receiving messages containing sensor data sent by the device 10. The broker 130 preferably performs a store and forward function to route the messages from the device 10 to the subscribers.

In a particular embodiment, the broker 130 runs one or more IOI communication protocols, such an MQTT (Message Queue Telemetry Transport) messaging protocol, for example.

In an embodiment, one or more selected from the data processing entity 100, the database 110 and/or the end user applications 120 may subscribe to the broker 130 and thus receive data originating from sensors.

Preferably, the database 110 is directly connected wirelessly to the broker and receives and stores data from the device 10, the sensors 20 and/or the wearable device 70.

The data processing entity 100 is preferably configured to run algorithms for determining comfort levels and/or for determining whether threshold levels of parameters and/or comfort ranges are trespassed or not, and possibly to what extent and/or for how long.

Following the application of the algorithms and/or rules, the data processing entity may connect to the broker and forward information to be output on the output entity 40, for example messages and/or information to be shown on displays and/or LEDs.

In an embodiment, the broker 130 provides an API 150, and the data processing entity 100 is configured to call the API and submit the data/information to be displayed. The broker may then either send a message to the device 10 comprising the display and/or directly start a function on the device which induces the output entity 40 to display the information or message.

In an embodiment, a packet composition format is preferably designed for communicating the messages to be sent to the device 10. Each message preferably carries the identifier of device 10 and the string message to appear on the screen. Preferably, each message further carries the color and/or intensity of light in each LED.

Preferably, the system of the invention provides for appropriate security, in particular of user data. For example, the inward and outward communication with the device 10 may take place via a server broker 130, such as an MQTT server, which preferably provides adequate security measures at the network, transport, and application levels.

FIG. 3 schematically represents a particular, exemplary implementation of the system of the invention. The device 10.3, also referred to as “comfort box”, preferably comprise input and output units 40, 60 as described herein above, wherein output unit comprises a screen 40.1 suitable to display text and an array of LEDs 40.2, suitable to indicate, for example, the duration of an uncomfortable situation. For example, the more LEDs are lighted in a particular color, the longer the uncomfortable situation persists.

In an embodiment, the system of the invention provides several devices 10 (not shown), for example several devices connectable to a single broker 130. Also in this case, each device is preferably associated with a particular user and/or locations, and the system manages several different devices, users and/or locations comprising a device. If there are a plurality of devices 10, the devices may use a single broker 130 or several brokers for transmitting data to the server 100, for example.

The device 10.3 is preferably configured to send and/or emit messages with sensor data immediately to the broker 130, which in this example is an MQTT broker but which may be any type of broker and may use any system of data exchange between the components of the system of the invention.

The smartphone or computer tablet 120.1 and the computer 120.2 are exemplary end user applications that have subscribed to the broker 130 and thus receive information 30.1 from the latter. This information preferably comprises live data 30 provided by the device 10.3. Input from the database is generally not required from the end user application in this embodiment. The present invention does, however, not exclude the possibility of end user applications receiving input and/or having access to data from the database 110.

The database 110 may also subscribe to the broker 130 or, alternatively, establishes a constant connection with the broker and stores data in real time.

The data processing entity 100 preferably subscribes to the broker 130 and applies rules/algorithms and decides about the information 50 to be output on the output unit 40 (40.1 and 40.2). In the particular embodiment shown in FIG. 3, the data processing entity 100 is preferably a webserver comprising the central algorithm. The webserver may also connect to the database 110, for example for obtaining user preferences information 30.3, received via the input unit 60, or any other data stored in the database 110. The data 50 may sent to the broker 130 and may be displayed, for example via an API 150, on the device 10.3.

In an embodiment, the data processing entity 100 uses environmental data 30.2 and/or user data 65 as script input, preferably together information 30.2 accessible on the database 110 as input to the algorithms and rules contained in the data processing entity 100. The output 50 is thus preferably the result of the input 30.2, 30.3 and 65 and the application of said algorithms.

Reference numeral 140 in FIG. 3 preferably refers to an interface configured, for example for data analysis and data visualization. For example, a programmer or, possibly an end user application, may access the information on database 110.

The webserver 110 further sends and/or emits information with respect to the information to be output, preferably displayed, on the output unit 40.1, 40.2 of the system. In the embodiment shown, the data emitted by the webserver is directly received by the device 10. As indicated above, the data is preferably sent from the webserver 110 to the device 10.3 via a broker 130.

In an embodiment, the method, device and system of the invention comprise and/or are configured to output via said output unit 40 an appropriate information in the event that the value of an environmental parameter and/or comfort level is beyond or below a tolerance range and/or threshold. The output can be in the form of a warning, using appropriate colours and/or light intensity, or appropriate message language 40.1, such as, for example, “warning”, “CO₂ level is too high!”, “It is hot”, and so forth.

In an embodiment, the method, device and/or system of the invention comprise and/or are configured to inquire of said individual to provide input via said input units 60 with respect a comfort as perceived by said individual.

In other words, the system and/or device of the invention is configured to engage in and/or initiate a dialogue with the individual. The invention preferably provides generating a “comfort conversation” between the individual and the system of the invention. For example, feedback from the individual may be required or asked if a particular threshold and/or comfort value is trespassed and the data processing entity has determined that at a particular moment or situation the environment represents a uncomfortable situation. For example, if a temperature is below a particular limit value, the system may send data 50 to the output device 40, such that the latter displays a question such as “Do you feel cold?”, or simply make a statement “It is cold, please provide feedback.”.

The invention provides the possibility for the individual to confirm, negate and/or render more precisely a statement or question displayed on the output unit 40, for example by providing buttons or other input means set out elsewhere in this specification. In other words, the invention provides requesting and/or receiving an individual's input related to the actually perceived comfort.

The invention preferably provides forwarding the individual's information or feedback 65 (FIGS. 1 and 2) to the data processing entity 100 and/or to the database 110.

The invention preferably provides integrating and/or considering the individual's perceived comfort when determining comfort level by way of the algorithms used by the data processing entity 100. To make an example, the system of the invention may learn, from the input related to perceived comfort, that a particular individual feels comfortable when the temperature in accommodation and/or office is higher compared to the average preferences. Accordingly, the system produces a warning message with respect to comfort, such as “It is hot!”, while taking the individual's particular preference with respect to temperature into account. In this manner, the invention preferably provides output, such as messages, warnings, comments related to comfort, in dependence of the individual's preferences.

In accordance with the above, a particular comfort level is preferably determined from environmental parameters 30 measured by one or several sensors 20 and, if available, from the individual's feedback related to perceived comfort. Preferably, if an individual's feedback is absent, the comfort level may be determined based on information contained in the algorithms initially, which may be based on average preferences. The algorithms are preferably susceptible of auto-updating and/or auto-adapting. For example, the algorithms may make use of variables the value of which is determined by the input received from the individual, for example via the input unit 60, and/or possibly from the wearable device 70.

Data related to “perceived comfort”, generally received via the input unit 60, may preferably be used to adapt threshold and/or limit values, tolerance ranges, and so for, used for distinguishing a “comfortable situation” from an “uncomfortable situation”, and/or for determining (semi-)quantitatively the extent by which a comfortable situation is exceeded.

In an embodiment, the method comprises and/or the system and device is configured to determine a personal and/or individual comfort level from said measured environmental parameters 30 and from the input provided by said individual via said one or more input units 60 with respect to the perceived comfort.

The system, device and/or method of the invention preferably comprise and/or are configured to enable an individual to initiate a conversation with the system, preferably to provide feedback, input and/or information even in absence of a message output by the output entity 40. Such feedback, input and/or information is generally related to perceived comfort.

For example, the system and/or input device preferably enables the individual to inform the system about the perceived comfort. Generally, an individual is expected to use this option in case the output does not indicate an “uncomfortable situation”, but the individual feels uncomfortable. For example, the individual may inform the device by inputting information like “I feel hot”, “there is not enough light”, “it is noisy”. The system and or method provides taking into account, in said algorithms and/or rules, information received from said individual, also on the own initiative by the individual. Preferably, the system enables an individual to provide information unasked and may also actively ask to provide information.

Preferably, the system may, following the inputting of perceived comfort information, produce a warning and/or to output information with respect to comfort if it determines, from input received by a particular individual, that in a particular situation the individual that is associated with the device will not feel comfortable, for example will feel too hot, cold, etc.

As it becomes clear from the above, one device 10 is generally associated with one individual, and will output information related to the comfort as perceived by that particular individual.

In a preferred embodiment, the invention provides measuring and/or determining “physiological comfort”. In an embodiment, the method, system and/or device comprises and/or is configured to determine, from said physiological or biological parameters, a physiological comfort level of said individual or an overall comfort level taking into account said physiological comfort level of said individual and environmental parameters 30.

Preferably, the system of the invention comprises a wearable device 70, as discussed in more detail elsewhere in this specification. The wearable device is preferably suitable to be worn by an individual, for example associated with (and/or wirelessly connectable with) a particular device 10. The wearable device preferably comprises one or more sensors measuring data related directly to the physiology of an individual, such as heart rate, body temperature, skin conductance, for example. The data measured by the wearable device 70 is preferably emitted and/or sent, to be received at the data processing entity 100 and/or the database 110.

When determining comfort of an individual, the algorithms and/or rules preferably take into account the data produced by the wearable device 70 and therefore may determine a comfort level on the basis of “physiological comfort”. For example, the data produced by a temperature and/or skin conductance method may be used by the data processing entity to deduce that an individual is hot and/or sweating, and, as a consequence, may display according information at the output device 40, even though ambient temperature may not be beyond a threshold value.

In a preferred embodiment, the method comprises producing and/or the system or device is configured to produce output at the output entity 40 related at least partially to physiological data and/or physiological comfort of an individual.

As has been indicated above, the invention preferably provides the possibility of end user applications 120.1, 120.2′ to connect to the system and/or to subscribe so as to receive information, for example with respect to user input provided by the input unit 60. The possibility and versatility of such end user applications is an advantage of the invention, and the invention encompasses any conceivable end user application. The invention enables the use and/or interaction with any type of end user applications. Webbrowsers, mobiles (mobile phones, computers, laptops) have been mentioned, but one may envisage any other type of application.

In an embodiment, the end user applications may be selected from one or both of the following types: (i) Input to buildings and/or to the building control. This input is generally directed to the manager, conceiver and or constructor of a building, including building managers, caretakers, architects, and the like. They may, for example, use the information received from the system 1 or 1.1 for deciding on measures concerning the building as a whole or on the construction and/or management of future buildings. The information may also be used, for example, for better understanding the user's use of the building and/or behaviour in the building.

Another type of end user applications (ii) concerns the user of the building and/or occupation awareness. For example, the end user application may be an application on mobile, such as a smartphone, and a user of the building may learn about locations in the building where comfort corresponds to the user's preferences. For example, a user of a public building, such as a university, may be informed about locations in the building where acoustic comfort is favourable to studying, and the like. End user applications may, for example, be used by users of a public building, such as the public buildings mentioned elsewhere in this specification (university, hospital, museum, etc). However, end user applications may be available to an inhabitant of a house, where the user can be informed about the comfort situation of his or her home, while being absent from home.

In an embodiment, the end user application provides for a visualisation of a comfort situation in a building. In an embodiment, the end user application comprises or uses a screen or any other type of output entity for providing information to the end user.

The system of the invention may preferably be equipped with interfaces for programmers (not shown in the figures), for example interfaces allowing a connection to the data processing entity 100 and/or to the database 110. Such interfaces preferably allow a programmer to act on the algorithms and/or software, for example to update a software of the system of the invention.

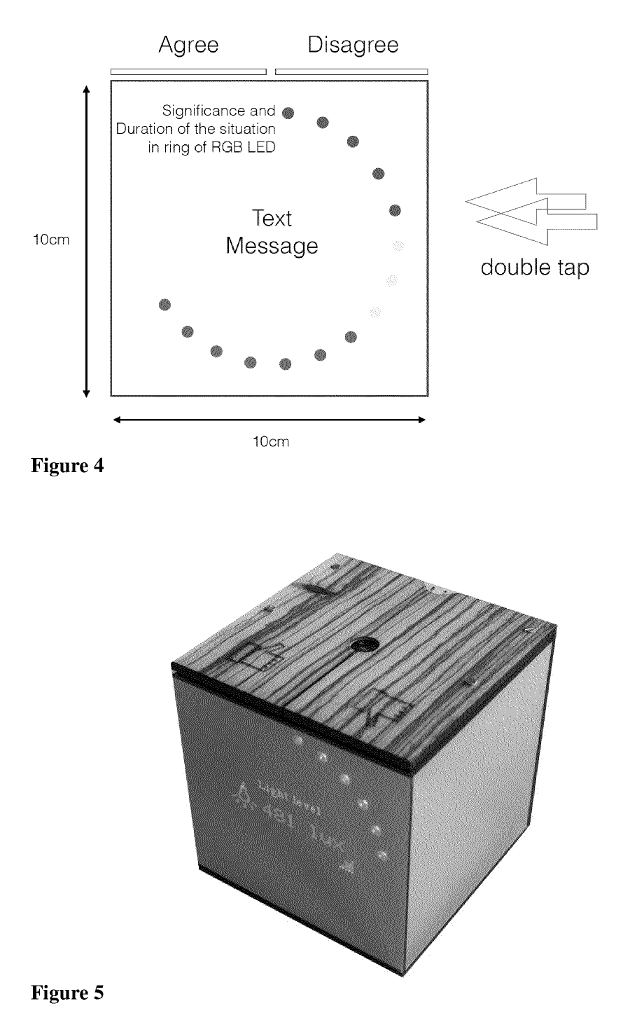

FIGS. 4 and 5 show specific embodiments of devices according to the embodiment 10.3 specified above, where the device comprises a screen or display configured to display a text or symbols, as well as two input buttons on the top (“agree”, “disagree”).

The screen preferably comprises a series of LEDs, which may, for example, be arranged as an array or, as shown in FIG. 4, along a ring. The LEDs may be used to indicate the significance and the duration of a situation potentially relevant to comfort. For example, the more of the LEDs along the array and/or along the ring are lighted, the longer an uncomfortable situation is being determined by the system, or the more significantly a particular threshold level is trespassed. Different colors may be used in addition and/or alternatively for displaying such information. The LED's may thus be used to convey a gradual and/or semi-quantitative information to an individual with respect to the duration of a “non-ideal” (uncomfortable) situation and/or with respect to the extent of deviation from said “non-ideal” (uncomfortable) situation. The text display may be used to indicate the environmental or physiological parameter that is concerned, or the comfort type (thermal, acoustic, etc).

By double tapping the device in FIG. 4 on the right side (two horizontal arrows), the individual may indicate that he/she wishes to provide input with respect to perceived comfort. Of course, the device may be conceived in any possible alternative way for allowing an individual to enter such information and provide feedback on his or her own initiative.

FIG. 5 shows a photograph of a device referred to as “comfort box” in the form of a cube, which, in the present case, has edges of 10 cm length, but which may have any other dimension. On the front side, the cube has a display as specified above with respect to FIG. 4, and on top of the tube there are two buttons, allowing an individual to interact and provide information with respect to perceived comfort. The individual may tap on the right side of the device, as mentioned above with respect of FIG. 4, for providing input on the individual's initiative.

In an embodiment, once the individual has initiated information input via the input entity 60, the device and/or system may be configured to run through a series of questions addressing one, several or all comfort dimensions. For example, once being knocked on, the device may display one or more questions like: “Is it hot?”, “Is it cold?”, “Is it noisy?”, “Is it too bright?”, “Is it too dark?”, and so forth, and the individual may confirm or negate, or enter more precise responses, resulting in data 65 transmitted to the data processing entity 100 for integration in the algorithms and/or for storage in the database 110.

The device 10 of the invention is preferably configured to operate in the system 1 of the invention.

The functioning and operation of the system and device of the invention can be set out and understood in the light of the above description. The sensors of the device 10 measure environmental parameters and send the corresponding data 30, for example via broker 130, to a data processing entity 100, for example a webserver. The data processing entity 100 checks whether the data received represent a situation where the comfort of an individual is hampered, such as the environmental comfort. For example, the algorithms in the data processing entity may state that the noise level is higher than a threshold value representing the threshold for acoustic comfort.

Accordingly, the data processing entity 100 emits a message to be displayed on the display and indicating that the noise level is too high. For example, the message displayed may indicate the extent of the noise that exceeds the threshold value by lighting several LEDs or lighting LEDs with well visible colors, such as red, or use higher light intensities when lighting the LEDs. The display may be used to indicate a message like “there is too much noise!”. The same may apply in an analogous manner to other comfort dimensions, for example related to temperature, air quality, and luminosity, for example. With the (predicted) “uncomfortable situation” continuing, the system 1 (the data processing entity 100) may display on output unit 40 an indication of the time duration that the “uncomfortable situation” persists, for example by lighting more and more LEDs of an array or string of LEDs, or by increasing light intensity of LEDs, or in any other suitable way.

An individual noticing the output provided by the output unit 40 may interact with the device 10, for example by agreeing and/or disagreeing with the message indicated. The individual thus interacts via the input unit 60, for example comprising two buttons as shown in FIGS. 4 and 5, by pushing an appropriate button.

The individual's feedback 65 provided via the input unit 60 is also emitted by the device 1 and is preferably stored on a memory, for example on a database 110, to which the data processing entity 100 has access. For example, in case the individual has indicated that for him/her, it was not too noisy (not too hot, etc), the data processing entity 100 is preferably configured to take the individual's feedback into account when producing further messages to be output by the output unit 40. For example, the data processing entity 100 may adapt, for example increase the threshold value that for the individual in question is relevant with respect to acoustic comfort. In this manner, the system and device of the invention are configured to manage and/or improve environmental and perceived comfort of an individual.

As becomes clear, a particular device is preferably associated with a particular individual, such that the perceived comfort is determined with respect to a particular individual and adapted to the individual. For example, the device may be installed on the office desk of an individual, and may be thus be configured to determine, manage and/or improve comfort of the very individual having his/her working place at that particular desk.

The present inventors have found that there is a significant time lag between the time when the environmental condition is outside of the comfort zone (for example high CO₂ level), and the time when the inhabitants of that environment notice discomfort and react. This can happen several times during a day for an individual and can cause serious health problems for her/him. The first user application of the device and/or system of the invention is to notify its users about such extreme situations and eventually provide healthier conditions in offices, home, school, etc.

The device and/or system of the invention is an interactive device containing a combo of sensors to capture environmental comfort: temperature, light, noise, CO₂, air flow, and pressure sensors. While sensing the ambient surrounding, it engages its users (office building occupants) in a dialogue to capture the perceived comfort. The dialogues are preferably opportunistically initiated. For example, the dialogue begins at particular moments, for example when the comfort box sensors predict an upcoming transition to a discomfort situation (“uncomfortable situation” or “predicted uncomfortable situation”).

Typically, a “comfort conversation” is initiated by the device 10, when it realises that for example the level of CO₂, for example, is reaching the unhealthy threshold or the ambient temperature is approaching the discomfort zone. In such situations, which are defined for each experiment case differently and depending on the research question in hand, the device shows a message and conveys its significance using, for example a ring a RGB LEDs. For example, the more red the more critical the situation and the more complete the ring the longer time since the situation has been detected as noticeable. Two buttons on top of the device, or any other suitable input means, allow for giving positive or negative answer/feedback to the question/message displayed on the box.

A different color or other type of message and/or communication may also be used, for example, when a particular comfort type or environmental parameter is close to a threshold value. For example, a warning color may be used when a threshold value or range is probably going to be trespassed soon or is close to being trespassed. For example, yellow light (e.g. one or more yellow LEDs) may be used in such a situation. As mentioned, green light may be used if comfort is well within threshold values and red if there is an (predicted) uncomfortable situation, that is, threshold values and/or ranges have been trespassed.

In addition, for example by double tapping on the sides of the device, the user/individual can navigate through the dimensions of the comfort (e.g. reading the current temperature or CO₂ values), and this way does not need to wait for the device to initiate the conversation.

The device and/or system of the invention is preferably an adaptive technology that “learns” users preferences from his/her interactions and adapts the feedback and content displayed accordingly. The man-machine dialog is designed so that to produce a personal companion for comfort.

The invention allows addressing several goals that can be classified in two families: (1) augmenting comfort through manual control (e.g. opening windows, turning on light) thanks to a better user's awareness of his own comfort and (2) augmenting comfort through automatic control thanks to the communication between the comfort box and the building automation system.

The invention can also be used for post-occupancy analysis to evaluate building performance in terms of indoor experience and in the development of energy efficient built environments while satisfying the occupants' comfort needs.

The invention may also be used for improving productivity and/or improving health of an individual. It is known that uncomfortable situations may impact on human's health and productivity at work. Accordingly, by informing and warning about the occurrence of uncomfortable situations, the present invention allows maintaining and/or health and productivity, including productivity at work, for example in the office.

In an embodiment, the method of the invention comprises the step of avoiding an uncomfortable situation and/or reducing the time lag between occurrence and remediation of said uncomfortable situation. This can be achieved thanks to the warning and/or information rendered available, for example on the output unit, by the system of the invention. As mentioned above, comfort may be augmented by through manual or automatic control (e.g. opening a window, building automation), thereby impacting positively on health and productivity.

While certain of the preferred embodiments of the present invention have been described and specifically exemplified above, it is not intended that the invention be limited to such embodiments. Various modifications may be made thereto without departing from the scope and spirit of the present invention.

In particular, while the present specification sets out an exemplary system architecture for the system, devices and method of the invention, the skilled person may easily conceive other architectures achieving the same objectives and benefits related to comfort in buildings in accordance with the invention.

1. A system for determining, managing and/or improving comfort of an individual in a building, space, an accommodation, a habitat, and/or a vehicle, the system comprising:
a device comprising a plurality of sensors for measuring environmental parameters in said building, space, accommodation, habitat, and/or vehicle;
wherein said system is configured to determine a comfort level and/or status based on said measured environmental parameters, wherein said comfort level is established for one or for several comfort types combined or separately;
wherein said system is further configured to determine one or more discomfort patterns, said discomfort patterns indicating the occurrence of an uncomfortable comfort level or an uncomfortable situation;
wherein the device further comprises:
an output unit,
wherein said system is configured to output signals and/or information related to said comfort level on said output unit;
one or more input units configured to be used by said individual to provide input with respect to perceived comfort, said perceived comfort being related to a comfort level or situation as perceived by said individual,
wherein said system is configured to output on said output unit information and/or warning in the event that a discomfort pattern occurs or is predicted to occur.

2. The system of claim 1, which is configured to induce or invite said individual to provide input via said one or more input unit with respect to said comfort level as determined by the system and output on said output unit, and/or with respect to the occurrence or prediction of said uncomfortable comfort level.

3. The system of claim 1, which is configured to determine an individual comfort level, and/or an individual comfort pattern based on said measured environmental parameters and further based on the input received from said individual via said one or more input unit.

4. The system of claim 1, which is configured to output on said output unit information related to the amount of time that has passed since an uncomfortable comfort level and/or a discomfort pattern has occurred.

5. The system of claim 1, which is configured to determine:
a) whether a discomfort pattern is predicted to occur within a predetermined period of time; and/or,
b) that a comfort level is in a predetermined vicinity of a discomfort pattern;
said system being configured to determine the occurrence of an imminence of a discomfort pattern if the conditions under a) and/or b) are met;
wherein said system is further configured to output on said output unit information or a warning related to said imminence of discomfort pattern.

6. The system of claim 1, wherein said output unit is suitable to provide a gradual and/or continuous information related to said comfort level and/or related to said discomfort pattern.

7. The system of claim 1, which is configured to determine a comfort level for each of the comfort types of the group of: thermal comfort, visual comfort, acoustic comfort, and/or respiratory comfort.

8. The system of claim 1, wherein said plurality of sensors comprise one or more selected from the group consisting of: a temperature sensor, a humidity sensor, an air pressure sensor, an air flow sensor, a luminosity sensor, a sound sensor, a CO₂ sensor and an accelerometer.

9. The system of claim 1, which is configured to determine a thermal comfort level based on data received from one or more selected from: a temperature sensor, a humidity sensor, and an air flow sensor.

10. The system of claim 1, which is configured to determine an air quality comfort level based on data received from one or more selected from: a humidity sensor, an air pressure sensor, an air flow sensor, and a CO₂ sensor.

11. The system of claim 1, which is configured to determine luminosity comfort level based on data received from one or more luminosity sensors.

12. The system of claim 1, which is configured to determine an acoustic comfort level based on data received from one or more sound sensors.

13. The system of claim 9, which is configured to determine a discomfort pattern based on one or more selected from said thermal comfort level, air quality comfort level, luminosity comfort level, and acoustic comfort level.

14. The system of claim 1, which is configured to determine said comfort level and to request input with respect to a perceived comfort level with respect to at least two different comfort types.

15. The system of claim 1, wherein said device comprising said sensors, output unit and input unit is suitable for being positioned in vicinity of an individual so that said individual can physically interact with said device, and wherein said device is in communication with a remote data processing entity, which is configured to determine said comfort level and/or said discomfort pattern.

16. The system of claim 1, which further comprises one or more sensors and/or cameras for determining and/or measuring physiological or biological parameters of said individual.

17. The system of claim 1, which further comprises a wearable device to be carried by said individual, said wearable device comprising one or more of said sensors and/or cameras for determining and/or measuring physiological or biological parameters.

18. The system of claim 16, wherein said one or more sensors and/or cameras comprise one or more selected from: a sensor measuring skin temperature, a sensor measuring skin conduction, and a sensor for measuring heart rate.

19. The system of claim 16, which is configured to determine, from said physiological or biological parameters, a physiological comfort level of said individual or an overall comfort level taking into account said physiological comfort level of said individual and environmental parameters.

20. The system of claim 1, comprising a data processing entity, wherein said system is configured to transfer data related to said environmental parameters and/or input units to said data processing entity, and wherein said data processing entity comprises algorithms for determining said comfort level, said discomfort pattern, and/or for predicting the occurrence of a discomfort pattern.

21. (canceled)

22. (canceled)

23. A device comprising:
a plurality of sensors for measuring environmental parameters in a building, space, an accommodation, a habitat, and/or a vehicle;
an output unit configured to output signals and/or information related to said environmental parameters and/or to a comfort level determined at least partially from measured environmental parameters;
one or more input units configured to be used by said individual to provide input with respect to a perceived comfort, said perceived comfort being a comfort level as perceived by said individual.

24. (canceled)

25. A method for sensing, managing and/or improving comfort of an individual a building, space, an accommodation, a habitat, and/or a vehicle where the individual sojourns, the method comprising:
measuring environmental parameters in said space, accommodation and/or building;
outputting signals and/or information related to said environmental parameters and/or to a comfort level determined at least partially from measured environmental parameters; and,
requesting input from said individual with respect to a perceived comfort level, said perceived comfort level being related to a comfort level as perceived by said individual,
determining said comfort level at least partially from said measured environmental parameters and optionally from input received from said individual with respect to said perceived comfort.

26. (canceled)

27. The method of claim 25, comprises determining one or more discomfort patterns with respect to said comfort levels or status, said discomfort patterns indicating the occurrence of an uncomfortable comfort level.

28. The method of claim 25, comprising determining a comfort level for each of two or more different comfort types selected from the group consisting of: thermal comfort, visual comfort, acoustic comfort, and/or respiratory comfort.

29. The method of claim 25, further comprising measuring a physiological and/or biological parameter of said individual and determining a comfort level on the basis of said physiological and/or biological parameter and optionally on said one or more environmental parameters.

30. A method for improving productivity and/or improving health of an individual in a building, the method comprising:
measuring environmental parameters in said space, accommodation and/or building;
determining a comfort level and/or status based on said measured environmental parameters, wherein said comfort level is established for one or for several comfort types combined or separately,
determining or using one or more discomfort patterns with respect to said comfort level, said discomfort patterns indicating the occurrence of an uncomfortable comfort level or an uncomfortable situation,
generating an information and/or warning in the event that a discomfort pattern is determined to occur or is predicted to occur.

31. The method of claim 30, comprising requesting input from said individual with respect to a perceived comfort, said perceived comfort being related to a comfort level as perceived by said individual, and wherein said system takes said perceived comfort into account when determining said comfort level and/or said discomfort pattern.

32. The method of claim 30, comprising avoiding an uncomfortable situation and/or reducing the time lag between occurrence and remediation of said uncomfortable situation.
